(19) United States
(12) Patent Application Publication
(10) Pub. No.: US 2011/0036680 A1
(43) Pub. Date: Feb. 17, 2011

(54) BILL BOX

(75) Inventor: SUNG-CHING LIN, Taipei (TW)

Correspondence Address: INTERNATIONAL CURRENCY TECHNOLOGIES CORPORATION, P.O.BOX 108-00403, TAIPEI, 106, omitted

(73) Assignee: INTERNATIONAL CURRENCY TECHNOLOGIES CORPORATION, Taipei (TW)

(21) Appl. No.: 12/539,618

(22) Filed: Aug. 12, 2009

(51) Int. Cl. G07F 7/04

(52) U.S. Cl. 194/206

(57) ABSTRACT

A bill box includes a box body for receiving bills from a bill acceptor, and a bill hold-down mechanism, which has a frame base defining therein a bill passage in communication between the bill acceptor and the bill box, recessed portions at one side of the bill passage, a bill-transfer wheel set mounted in the frame base for transferring bills from the bill acceptor into the box body, a bill pusher device operable to push a bill away from the bill passage into the box body, and a non-return device mounted in the frame base for prohibiting back movement of a received bill. The non-return device includes a stop member pivotally mounted in the frame base and biasable into the recessed portion to block the bill passage and a follower member pivotally mounted in the frame base and movable by a bill to bias the stop member into blocking the bill passage when the bill is being pulled backwards after having been delivered into the box body.

### BACKGROUND OF THE INVENTION

1. Field of the Invention

The present invention relates to a bill box for using in, for example, an automatic vending machine to collect bills more particularly, to such a bill box that has a non-return device mounted in the frame base of the bill hold-down mechanism thereof for prohibiting back movement of a received bill.

2. Description of the Related Art

Following fast development of technology, our mode of living has been changed, and everything requires efficiency, time saving and quickness. In consequence, different automatic vending machines are used everywhere to sell different products without serviceman. These automatic vending machines are highly invited for the advantage of saving much labor and bringing convenience to people.

Nowadays, Q-shops are seen in many places to provide different services to consumers. A Q-shop has the advantages of scientific intelligence, quick service, and quick finish of payment. A Q-shop may provide automatic vending machines for vending drinks, cigarettes, tickets, ice creams, memorial coins, key rings, or even hamburgers and noodles. Further, many virtual shops are established to make online shopping, allowing shoppers to shop across millions of products.

Further, an automatic vending machine has a bill/coin box installed therein to collect bills or coins. An automatic vending machine provider needs to send security persons to collect the bill box of every installed automatic vending machine regularly and to simultaneously install an empty bill/coin box as a replacement for every bill box that has been taken back. However, except the period of bill box collection routine, automatic vending machines are not under the guard of a person. During this guard-free interval, evil persons may steal the collected money or tokens from the bill/coin box of each automatic vending machine or the storage tickets from each automatic vending machine.

Further, an evil person may fasten a wire member to a bill and then use the bill to cheat an automatic vending machine. An automatic vending machine may be equipped with a security hook behind a recognition device to prohibit backward movement of a bill that passed the examination of the recognition device. In order to cheat the security hook, an evil person may fasten a narrow elongated thin plastic strip to a genuine bill and then use this genuine bill to purchase a product from an automatic vending machine, and then insert a counterfeit bill into the automatic vending machine. When the counterfeit bill is rejected, the security hook is opened for letting the counterfeit bill be transferred backwards to the bill insertion slot. At this time, the evil person can pull the flexible connection medium to carry the genuine bill out of the bill box. By means of this method, the evil person can get the vending items from the automatic vending machine free of charge.

Accordingly, there is a strong demand for bill box for use in an automatic vending machine that prohibits backward movement of a received bill, preventing cheating.

### SUMMARY OF THE INVENTION

The present invention has been accomplished under the circumstances in view. It is therefore the main object of the present invention to provide a bill box for automatic vending machined that prohibits backward movement of a received bill, preventing cheating.

To achieve this and other objects of the present invention, a bill box comprises a box body for receiving bills from a bill acceptor, and a bill hold-down mechanism. The bill hold-down mechanism comprises a frame base defining therein a bill passage in communication between the bill acceptor and the bill box, recessed portions at one side of the bill passage, a bill-transfer wheel set mounted in the frame base for transferring bills from the bill acceptor into the box body, a bill pusher device operable to push a bill away from the bill passage into the box body, and a non-return device mounted in the frame base for prohibiting back movement of a received bill. The non-return device comprises a stop member pivotally mounted in the frame base and biasable into the recessed portion to block the bill passage and a follower member pivotally mounted in the frame base and movable by a bill to bias the stop member into blocking the bill passage when the bill is being pulled backwards after having been delivered into the box body. When a received bill is pulled backwards by a linked wire member or flexible connection medium, the bill will be curved to bias a pressure bar of the follower member toward the bill pusher device, causing the bearing portion of the follower member to turn the stop bar of the stop member about a pivot pin in direction reversed to the direction of rotation of the follower member, and a pointed portion of the stop member will be forced into the recessed portion to block the bill entrance, prohibiting the bill from being pulled outwards from the bill passage.

Further, the pressure bar of the follower member has a plurality of teeth protruded from the front side thereof. Each tooth of the pressure bar has hooked portions. When a linked wire member is carried by a bill into the bill passage toward the inside of the box body, the wire member will be kept between two adjacent teeth of the pressure bar. When the wire member is pulled to carry the bill backwards, the bill will force the pressure bar to bias, and will then be stopped by the teeth of the pressure bar.

Further, the bill pusher device has an array of hooks protruded from one side thereof and projecting in direction toward the inside of the box body. Further, each hook has a sloping stop face disposed at one side remote from the bill entrance. When a received bill is pulled by a linked wire member or flexible connection medium, the curved end of the bill will be stopped by the hooks of the bill pusher device and prohibited from being moved toward the outside.

Further, wire barrier hooks are respectively extended from stop blocks at two opposite lateral sides of the bill passage. If the wire member or flexible connection medium that is linked to a received bill is pulled backwards, the connection area between the wire member or flexible connection medium and the bill will be stuck in the groove of one wire barrier hook, prohibiting the bill from being pulled out of the box body.

### BRIEF DESCRIPTION OF THE DRAWINGS

FIG. 1 is an exploded view of a bill box according to the present invention.

FIG. 2 is an exploded view of a part of the present invention, showing the structure of the non-return device.

FIG. 3 is a sectional view of the present invention, showing an initial status of the bill box.

FIG. 4 is a sectional view of a part of the present invention, showing an operation status of the non-return device.

FIG. 5 is a sectional elevation of a part of the present invention, showing another operation status of the non-return device.

FIG. 6 is a sectional view of a part of the present invention, showing still another operation status of the non-return device.

FIG. 7 is a sectional view of a part of the present invention, showing still another operation status of the non-return device.

FIG. 8 is a sectional elevation of a part of the present invention, showing still another operation status of the non-return device.

FIG. 9 is an exploded view, showing the mounting relationship between the bill box and a bill acceptor according to the present invention.

FIG. 10 is an exploded view of an alternate form of the bill box according to the present invention.

### DETAILED DESCRIPTION OF THE PREFERRED EMBODIMENT

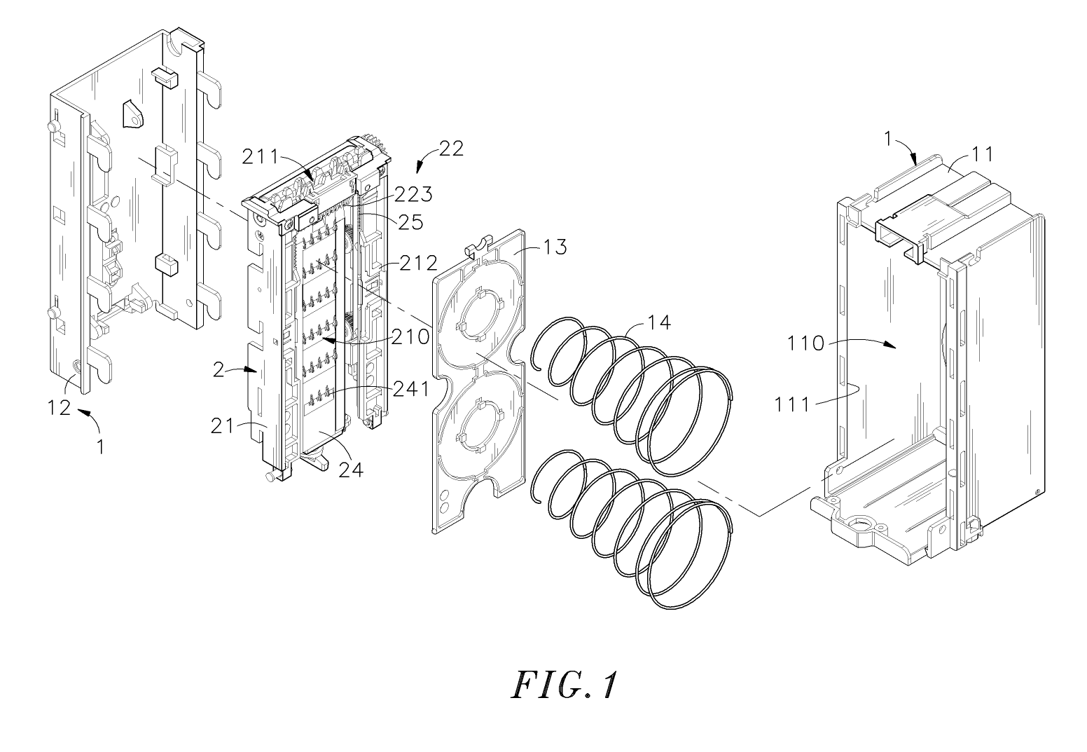

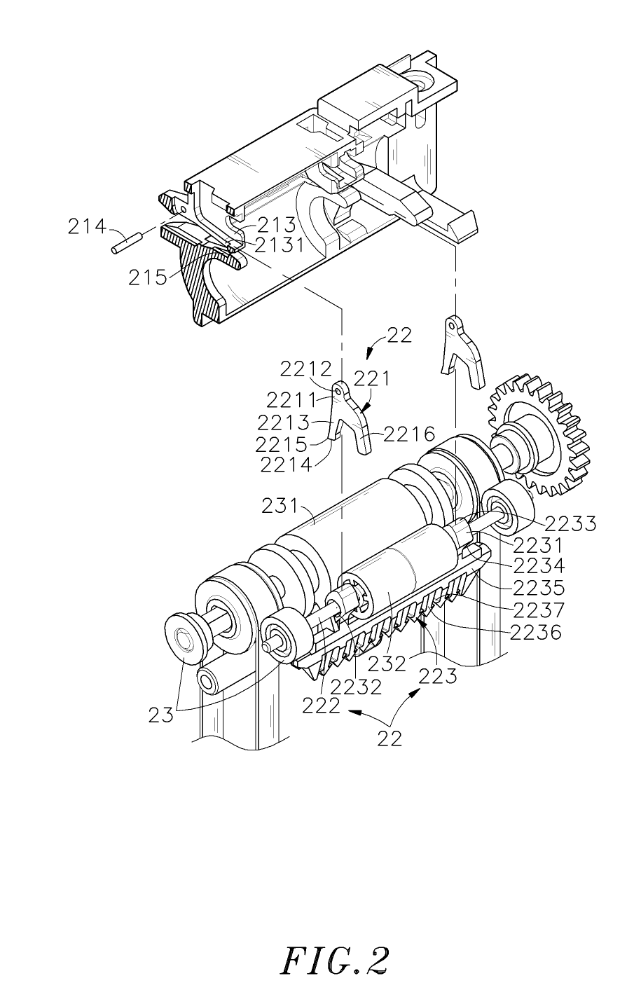

Referring to FIGS. 1 and 2, a bill box in accordance with the present invention is shown comprising a box 1 and a bill hold-down mechanism 2.

The box 1 comprises a box body 11, which defines therein an accommodation chamber 110 and an opening 111 in communication between the accommodation chamber 110 and the outside space, a cover 12 covering the opening 111, a plurality of spring members 14 located on the bottom side inside the accommodation chamber 110, a bearing board 13 supported on the spring members 14 in the accommodation chamber 110.

The bill hold-down mechanism 2 is positioned in the opening 111 between the cover 12 and the bearing board 13, comprising a frame base 21, a non-return device 22, a bill-transfer wheel set 23, a bill pusher device 24 and a plurality of wire barrier hooks 25.

The base frame 21 has a bill entrance 211 located on one end thereof for the entrance of a bill, a bill passage 210 in communication between the bill entrance 211 and the accommodation chamber 110, two stop blocks 212 disposed adjacent to the opening 111 at two opposite lateral sides relative to the bill entrance 211 for stopping the bearing board 13 against the spring members 14, at least one, for example, two slots 213 respectively disposed adjacent to each of the two opposite lateral sides relative to the bill entrance 211 in communication with the outside space, a hole 2131 cut through one sidewall of each slot 213, a pivot pin 214 mounted in each slot 213 and a recessed portion 215 disposed inside each slot 213 at a bottom side relative to the hole 2131 in the respective slot 213.

The non-return device 22 comprises at least one, for example, two stop members 221, an axle member 222 and two follower members 223. The stop members 221 are respectively coupled to the pivot pins 214 in the slots 213 of the base frame 21. Each stop member 221 has a coupling base 2211, a pivot hole 2212 cut through the coupling base 2211 and coupled to the pivot pin 214 in one slot 213 of the base frame 21, a stop bar 2213 extended from the coupling base 2211 toward the inside of the bill passage 210 above the bearing board 13 and suspending at one side relative to the associating follower member 223 and terminating in a stop face 2214 for stopping the inserted bill 3 against biasing, a pointed portion 2215 protruded from one side of the stop face 2214 opposite to the accommodation chamber 110, and a push bar 2216 extended from one side of the connection area between the coupling base 2211 and the stop bar 2213 and suspending at an opposite side relative to the associating follower member 223. The axle member 222 is mounted in the frame base 21 to support the follower members 223. Each follower member 223 has a base 2231, an axle hole 2232 cut through the base 2231 for the passing of the axle member 222, a bearing portion 2233 located on one side of the base 2231 corresponding to the coupling base 2211 of one associating stop member 221, a push portion 2234 protruded from the base 2231 and movable by the push bar 2216 of the associating stop member 221 to force the stop bar 2213 of the associating stop member 221 away from the associating recessed portion 215, a pressure bar 2235 extended from the base 2231 toward the bill passage 210 and reducing gradually in diameter in direction away from the base 2331 and biasable upon outward movement of a bill 3, a plurality of teeth 2236 protruded from the double beveled front side of the pressure bar 2235 and arranged in a staggered manner, and a plurality of hooked portions 2237 respectively protruded from one end of each tooth 2236 at two sides.

The bill-transfer wheel set 23 comprises a bill-transfer roller 231 pivotally mounted in the frame base 21, and a pinch roller 232 mounted on the axle member 222.

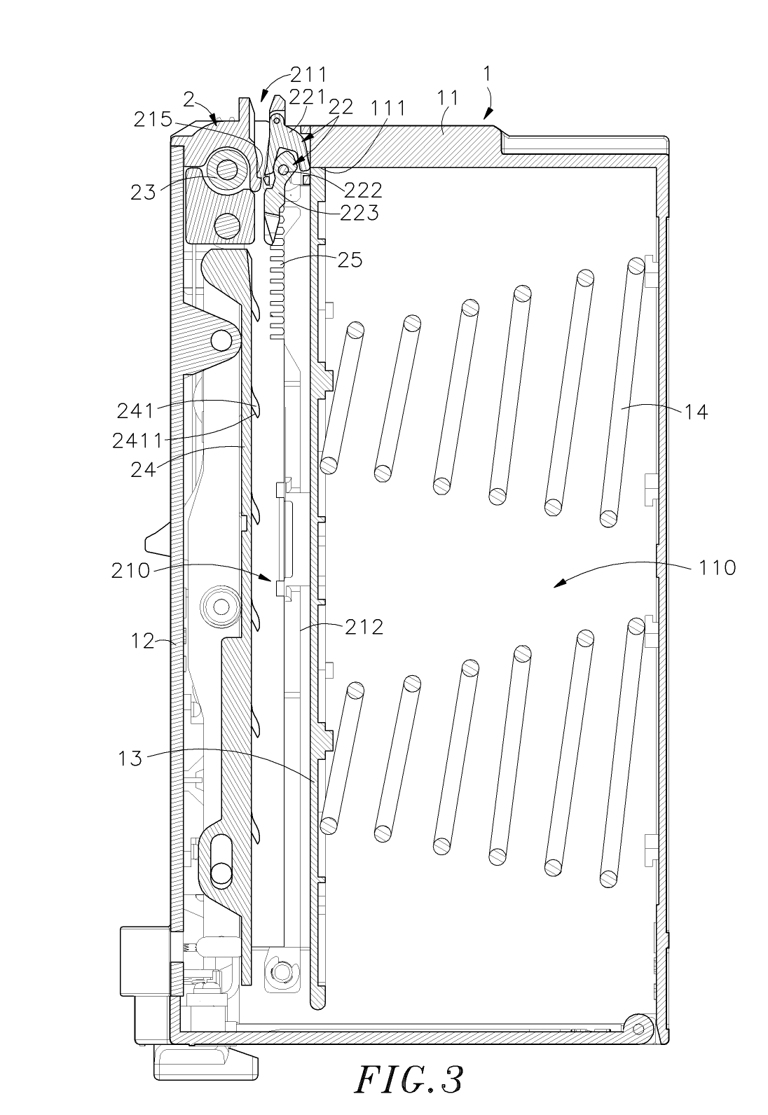

The bill pusher device 24 is disposed in one side of the bill passage 210 remote from the accommodation chamber 110 of the box 1 and movable through the space between the two stop blocks 212 for pushing a bill 3 out of the bill passage 210 toward the bearing board 13 (see FIG. 3). The bill pusher device 24 has an array of hooks 241 protruded from one side thereof and projecting in direction toward the accommodation chamber 110. Each hook 241 has a sloping stop face 2411 disposed at one side remote from the bill entrance 211 for stopping a bill 3 from backward movement.

The wire barrier hooks 25 are arranged in the frame base 21 and respectively extended from the stop blocks 212 at two opposite lateral sides relative to the opening 111, each having a groove 251 curving toward the accommodation chamber 110 and two sloping guide faces 252 at two sides of the groove 251.

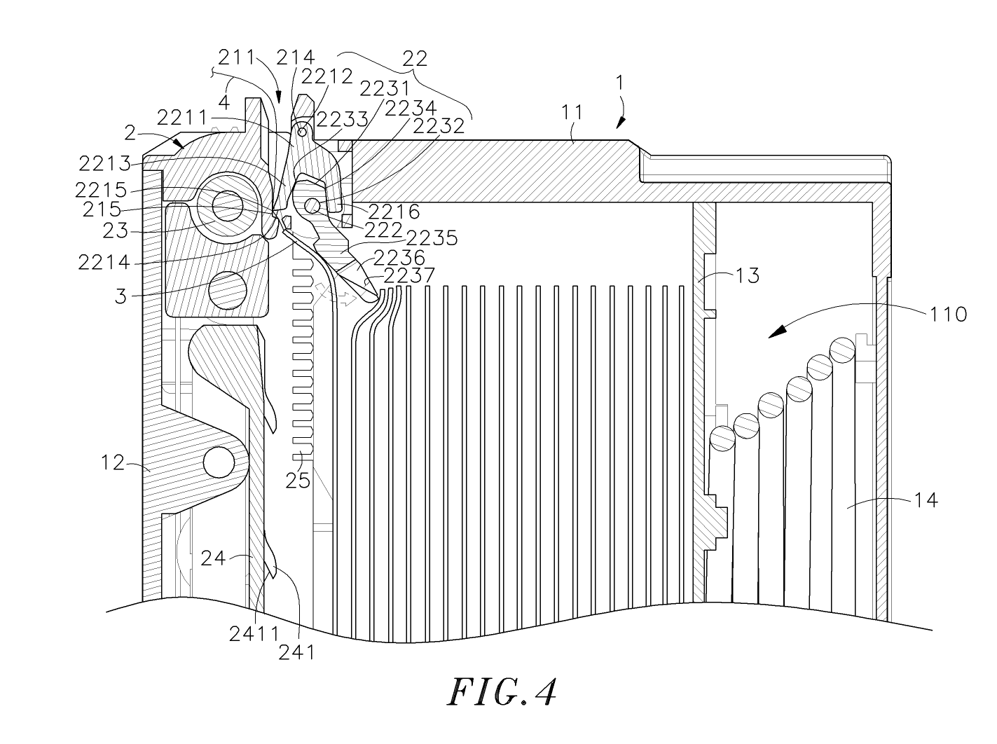

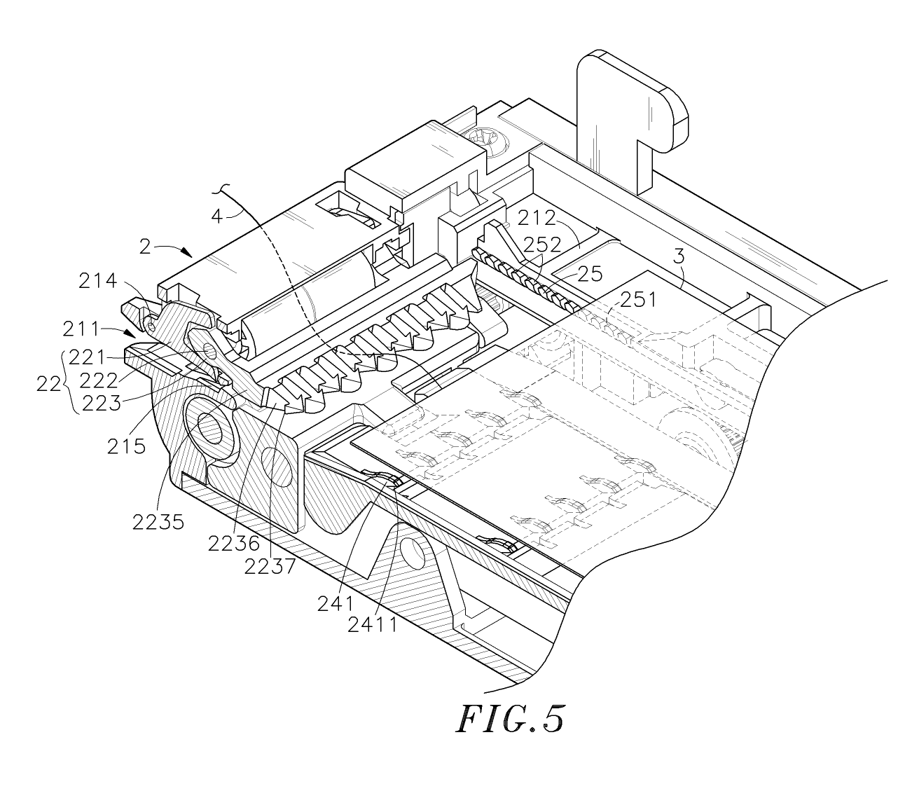

Referring to FIGS. 1, 2, 3 and 5, the stop members 221 of the non-return device 22 are respectively pivotally coupled to the pivot pins 214 in the slots 213 of the base frame 21. Subject to the limitation of the slots 213 and the holes 2131 in the slots 213, the top members 221 are rotatable bout the respective pivot pins 214 in source within a limited range. An opening 111 may be directly formed on each of two opposite lateral sides of the frame base 21 corresponding to the bill entrance 211 to substitute for the slots 213 and the holes 2131, and stop means may be provided at the two ends of each pivot pin 214 to limit the angle of rotation to a predetermined range. Further, according to the present preferred embodiment, the axle member 222 of the non-return device 22 is inserted through the axle holes 2232 of the bases 2231 of the follower members 223. Alternatively, two axles may be used and respectively inserted through the axle holes 2232 of the bases 2231 of the follower members 223 to support the follower members 223 in the frame base 21. Further, the bill-transfer roller 231 and pinch roller 232 of the bill-transfer wheel set 23 are adapted to transfer a bill 3 from the bill entrance 211 into the bill passage 210 to a predetermined location for pushing by the bill pusher device 24 away from the bill passage 210 to the bearing board 13 in the accommodation chamber 110 against the spring members 14. Because the axle member supports can support one or a number of impression pinch roller 232, the design of the present invention saves space occupation. Further, arranging the non-return device 22 and the bill-transfer wheel set 23 needs not to consider their relative positioning, and therefore the design of the present invention is simplified. However, the follower members 223 and the bill-transfer wheel set 23 can be arranged at different locations or on different mechanisms for enabling the follower members 223 to be forced by the bill 3 to move the stop members 221 in opening/closing the bill entrance 211. Other modifications may be made thereunto without departing from the spirit and scope of the invention. When the bill pusher device 24 pushes a bill 3 away from the bill passage 210 to the bearing board 13, the two opposite lateral side edges of the bill 3 will be curved and moved over the stop blocks 212. When the bill pusher device 24 retracts after having moved one bill 3 to the bearing board 13, the spring members 14 push the bearing board 13 outwards to stop the newly collected bill 3 against the stop blocks 212. Thus, the newly collected bill 3 is received inside the accommodation chamber 110. Referring to FIGS. 1, 2 and 4, when an evil person fastens a wire member 4 to link a bill 3 and pulls the wire member 4 to move the bill 3 away from the accommodation chamber 110 in the box 1 over the stop blocks 212 into the bill passage 210 after a transaction is made. When this evil person continuously pulls the wire member 4 to move the bill 3 outwards, the pressure bars 2235 of the follower members 223 will be moved by the bill 3, causing the follower members 223 to be rotated about the axle member 222 toward the accommodation chamber 110. At this time, the bearing portion 2233 of each follower member 223 will be forced to move the stop bar 2213 of the associating stop member 221, causing the associating stop member 221 to be rotated about the associating pivot pin 214 in direction reversed to the direction of rotation of the associating follower member 223, and the pointed portion 2215 of each stop member 221 will be forced through the associating hole 2131 into the associating recessed portion 215 to block the bill entrance 211.

If the evil person keeps pulling the wire member 4 to move the bill 3 toward the bill entrance 211 after the pointed portions 2215 of the stop members 221 have blocked the bill entrance 211, the bill 3 will be forced against the stop faces 2214 of the stop bars 2213 of the stop members 221 and stopped from forward movement. If a Mylar film or plastic film is connected between the wire member 4 and the bill 3, the Mylar film or plastic film will be damaged and separated from the bill 3 by the pointed portions 2215 of the stop members 221 when reached the recessed portions 215, avoiding the bill 3 from being pulled out of the box 1. Further, when the evil person increases the applied force to pull the wire member 4 heavily after the bill 3 has been stopped by the stop faces 2214 of the stop bars 2213, the pressure give by the bill 3 to the pressure bars 2235 of the follower members 223 will be relatively increased, and the stop members 221 will give more pressure to the recessed portions 215, thus the bill 3 cannot push the stop members 221 away.

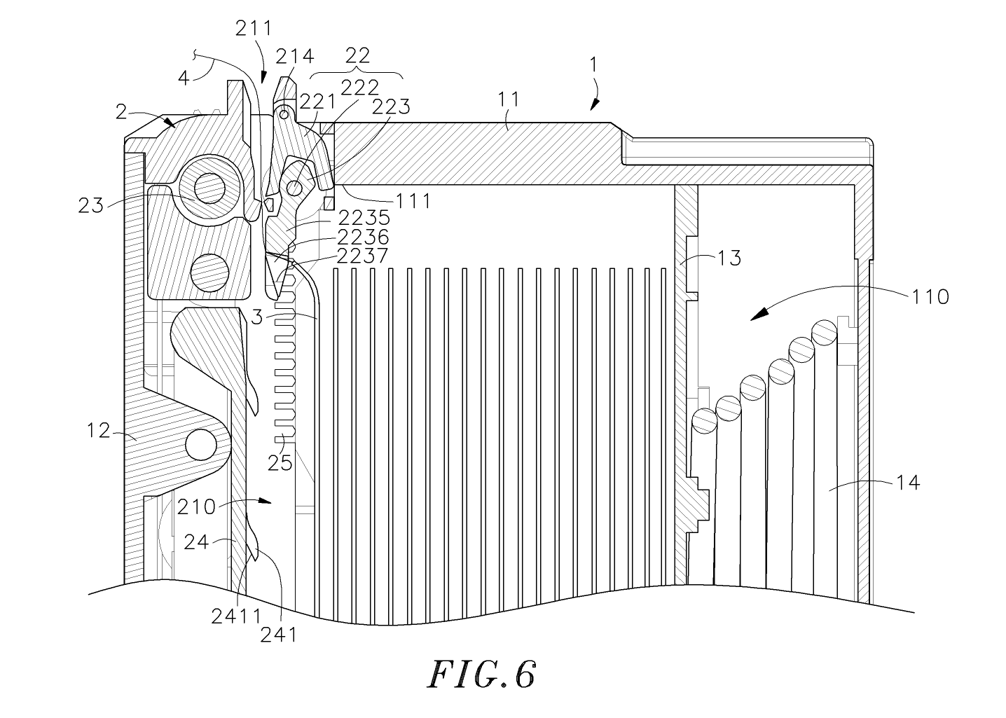

Referring to FIGS. 1, 2, 5 and 6, the teeth 2236 of each follower member 223 are respectively protruded from the double beveled front side of the pressure bar 2235 and arranged in a staggered manner, and the hooked portions 2237 are respectively protruded from one end of each tooth 2236 at two sides and the pressure bar 2235 of each follower member 223 projects into the bill passage 210. When a bill 3 is pushed by the bill pusher device 24 toward the accommodation chamber 110 in box body 11 of the box 1, the bill 3 will be forced against the pressure bar 2235 of each follower member 223, causing each follower member 223 to bias so that the bill 3 can pass. When the bill 3 passed over the follower members 223, the linked wire member 4 is carried forwards by the bill 3 and guided by one sloping side of one of the hooked portions 2237 to the gap between two teeth 2236 of one follower member 223. When the evil person pulls the wire member 4 backwards at this time, the bill 3 will be moved toward the bill passage 210 to bias the pressure bar 2235 toward the bill pusher device 24. Thus, the bill 3 is prohibited from being pulled outwards. Further, the hooked portions 2237 have a length greater than one half of the pitch between each two adjacent teeth 2236. Further, the teeth 2236 are arranged in a staggered manner. Thus, the wire member 4 must be rotated properly to escape from the hooked portions 2237. This arrangement avoids the wire member 4 from escaping out of the gap between the two teeth 2236 so that the pressure bar 2235 effectively stops the bill 3 from being pulled outwards.

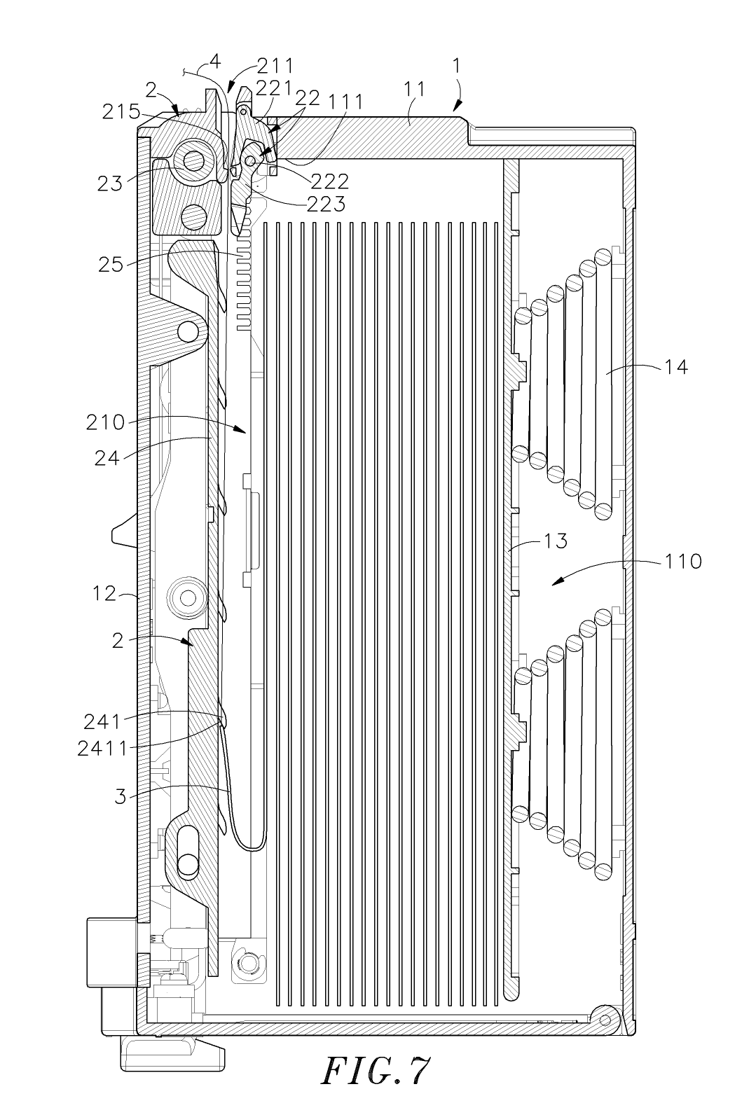

Referring to FIGS. 1 and 7, the thickness of the bill passage 210 allows a bill 3 to be reversed. When an evil person pulls the linked wire member 4 or flexible connection medium to reverse the bill 3 and to carry the bill 3 outwards from the accommodation chamber 110 toward the bill passage 210 after the bill 3 has been moved away from the bill passage 210 into the accommodation chamber 110 by the fill pusher plate 24, the limited thickness of the bill passage 210 will cause the front end of the bill 3 to be stopped at the sloping stop faces 2411 of the hooks 241 of the bill pusher device 24, prohibiting the bill 3 from being pulled out of the accommodation chamber 110 into the bill passage 210.

The aforesaid bill pusher device 24 can be a flat plate member, cam plate or any of a variety of other designs movable by a power drive means through a linkage or a roller or belt transmission device. Because the means to move the bill pusher device 24 is of the known design and not within the scope of the claims of the present invention, no any further detailed description will be necessary.

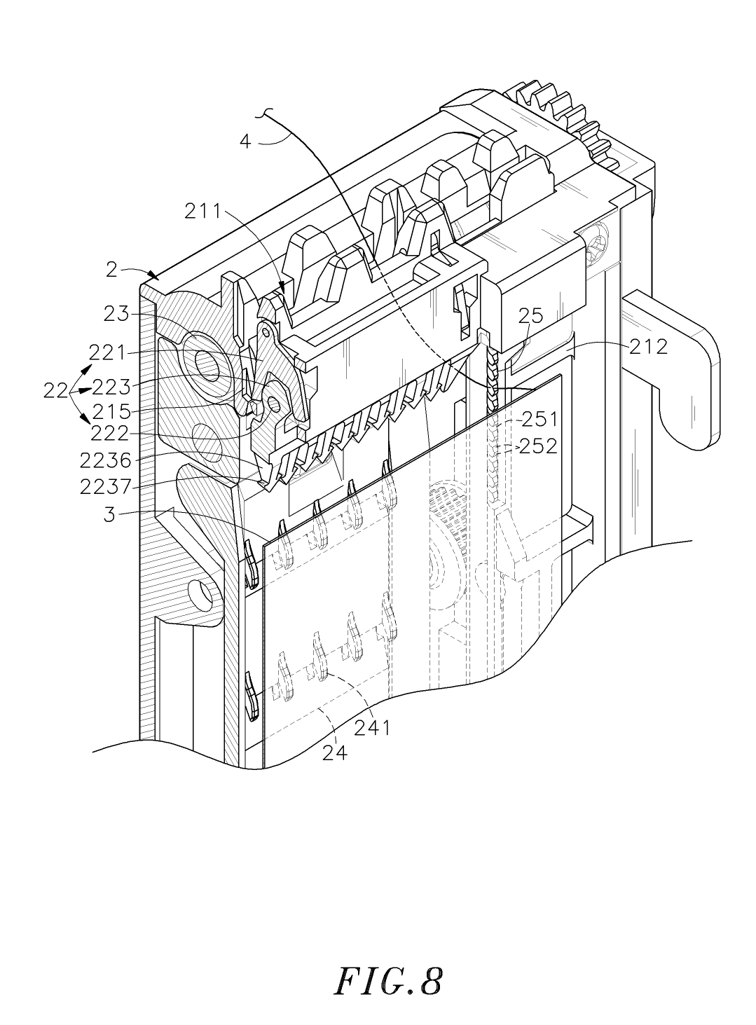

Referring to FIG. 8, the stop blocks 212 extend along the bill passage 210, and the wire barrier hooks 25 are arranged in the frame base 21 and respectively extended from the stop blocks 212 at two opposite lateral sides relative to the opening 111, each having a groove 251 curving toward the accommodation chamber 110 and two sloping guide faces 252 at two sides of the groove 251. When a bill 3 with the linked wire member 4 or flexible connection medium is delivered from the bill entrance 211 into the bill passage 210 and then the accommodation chamber 110, the wire member 4 or flexible connection medium tends to be deviated to one lateral side of the accommodation chamber 110 and supported between two adjacent wire barrier hooks 25. If the wire member 4 or flexible connection medium is pulled backwards at this time, the connection area between the wire member 4 or flexible connection medium and the bill 3 will be stuck in the groove 251 of one wire barrier hooks 25, prohibiting the bill 3 from being pulled out of the accommodation chamber 110.

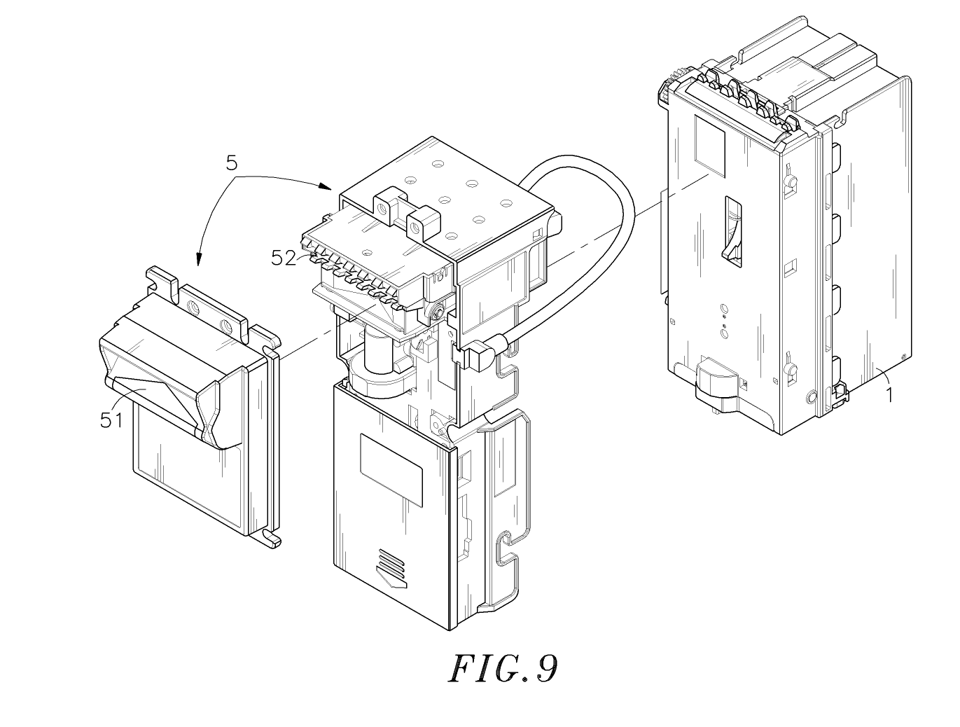

Referring to FIG. 9, the box 1 is fastened to the back side of a bill acceptor 5. The bill acceptor 5 has a bill insertion slot 51, a bill transfer passage 52 extended from the bill insertion slot 51 for guiding an inserted bill 3 into the bill entrance 211 of the box body 11 of the box 1.

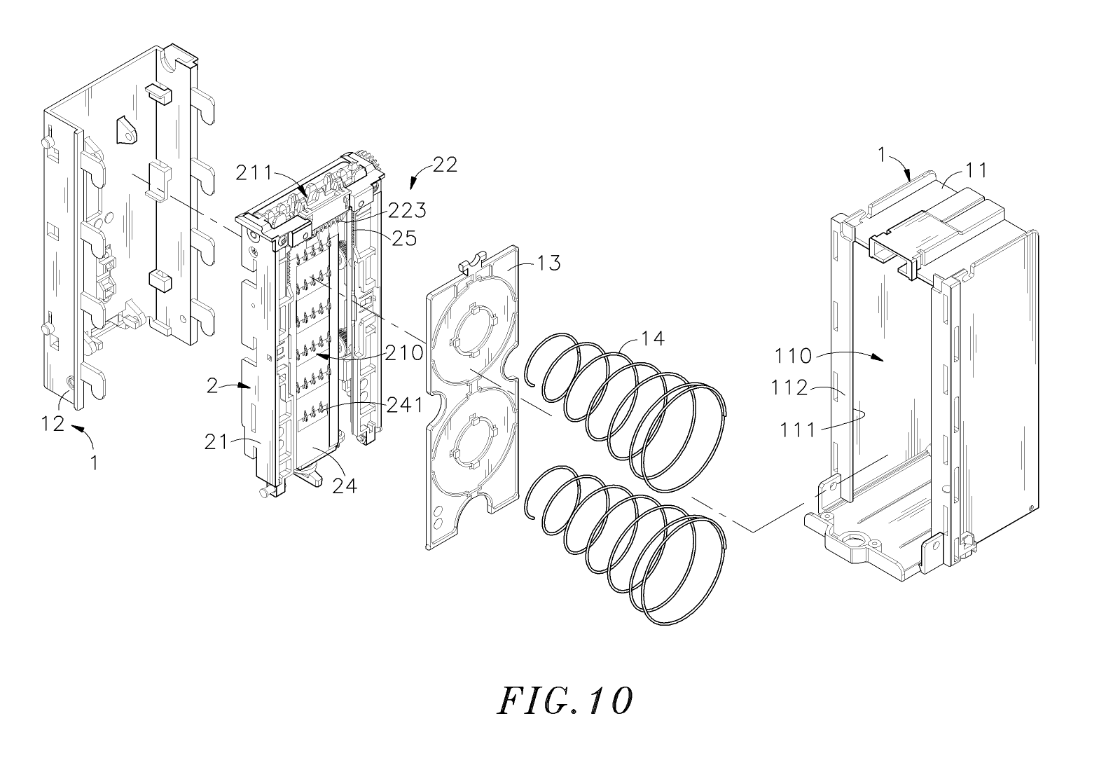

Referring to FIGS. 1 and 10, except the design of the stop blocks 212 at the frame base 21 of the bill hold-down mechanism 2 at two opposite lateral sides of the opening 111 of the accommodation chamber 110, the box body 11 of the box 1 can be made having two stop flanges 112 respectively perpendicularly extended from the two opposite side panels thereof and suspending in the opening 111 of the accommodation chamber 110 at two opposite lateral sides for stopping the bearing plate 13 to limit the moving range of the bearing plate 13 in the accommodation chamber 110.

As indicated above, the invention provides a bill box, which has the following features and advantages:

1. When a bill 3 is pulled backwards from the accommodation chamber 110 or bill passage 210 toward the bill entrance by a linked wire member 4 or flexible connection medium, the bill 3 will be curved to bias the pressure bar 2235 toward the bill pusher device 24, causing the bearing portion 2233 of the follower member 223 to rotate the stop bar 2213 of the associating stop member 221 about the associating pivot pin 214 in direction reversed to the direction of rotation of the associating follower member 223, and the pointed portion 2215 of each stop member 221 will be forced through the associating hole 2131 into the associating recessed portion 215 to block the bill entrance 211, prohibiting the bill 3 from being pulled outwards.

2. Each tooth 2236 of the pressure bar 2235 of each follower member 223 of the non-return device 22 has hooked portions 2237. When the linked wire member 4 is carried by the bill 3 into the bill passage 210 toward the accommodation chamber 110, the wire member 4 is kept between two adjacent teeth 2236. When the wire member 4 is pulled to carry the bill 3 backwards, the bill 3 will force the pressure bar 2235 to bias, and will then be stopped by the teeth 2236 of the pressure bar 2235 in the accommodation chamber 110 or the bill passage 210.

3. The bill pusher device 24 has an array of hooks 241 protruded from one side thereof and projecting in direction toward the accommodation chamber 110. Further, each hook 241 has a sloping stop face 2411 disposed at one side remote from the bill entrance 211. When a received bill 3 is pulled by a linked wire member 4 or flexible connection medium, the curved end of the bill 3 will be stopped by the hooks 241 of the bill pusher device 24 and prohibited from being moved toward the bill entrance 211.

4. The wire barrier hooks 25 are respectively extended from the stop blocks 212 at two opposite lateral sides relative to the bill passage 210. If the wire member 4 or flexible connection medium is pulled backwards after the bill 3 has been delivered to the accommodation chamber 110, the connection area between the wire member 4 or flexible connection medium and the bill 3 will be stuck in the groove 251 of one wire barrier hook 25, prohibiting the bill 3 from being pulled out of the accommodation chamber 110.

In conclusion, the pressure bar 2235 of each follower member 223 of the non-return device 22 will be biased by the bill 3 when the bill 3 is pulled backwards by the linked wire member 4 or flexible connection medium, causing the bearing portion 2233 of the follower member 223 to rotate the stop bar 2213 of the associating stop member 221 about the associating pivot pin 214 in direction reversed to the direction of rotation of the associating follower member 223, and the pointed portion 2215 of each stop member 221 will be forced through the associating hole 2131 into the associating recessed portion 215 to block the bill entrance 211 and to prohibit the bill 3 from being pulled outwards.

A prototype of bill box has been constructed with the features of FIGS. 1˜10. The bill box functions smoothly to provide all of the features discussed above.

Although particular embodiments of the invention has been described in detail for purposes of illustration, various modifications and enhancements may be made without departing from the spirit and scope of the invention. Accordingly, the invention is not to be limited except as by the appended claims.

What the invention claimed is:

1. A bill box, comprising:
a box body fastened to a back side of a bill acceptor for receiving bills from said bill acceptor, said box body having an accommodation chamber defined therein, an opening in communication between said accommodation chamber and the space outside said box body, and a bearing board movably suspending in said accommodation chamber for collection bills received from said bill acceptor;
a bill hold-down mechanism positioned in said opening of said bill box, said bill hold-down mechanism comprising a frame base, said frame base defining therein a bill passage in communication between said bill acceptor and said accommodation chamber of said bill box, a bill entrance at one side of said bill passage and at least one recessed portion at one side of said bill passage, a bill-transfer wheel set mounted in said frame base and adapted to transfer bills from said bill acceptor into said bill passage, a bill pusher device operable to push a bill away from said bill passage into said accommodation chamber of said box body, and a non-return device mounted in said frame base and adapted to prohibit back movement of a bill from said accommodation chamber, said non-return device comprising at least one stop member pivotally mounted in said frame base and biasable into said at least one recessed portion to block said bill passage and at least one follower member pivotally mounted in said frame base and movable by a bill to bias said at least one stop member into blocking said bill passage when the bill is being pulled backwards after having been delivered into said accommodation chamber, each said follower member comprising a base portion pivotally mounted in said frame base, bearing portion protruded from said base portion for moving one said stop member and a pressure bar extended from said base portion and movable by a backward moving bill to bias the respective follower member.

2. The bill box as claimed in claim 1, wherein said bill hold-down mechanism further comprises at least one pivot pin mounted in said frame base to pivotally support said at least one stop member; each said stop member has a coupling base, a pivot hole cut through said coupling base and coupled to one said pivot pin in said base frame and a stop bar extended from said coupling base for engaging into one said recessed portion.

3. The bill box as claimed in claim 2, wherein the stop bar of each said stop member has a stop face for stopping against a bill and a pointed portion protruded from one side of the stop face.

4. The bill box as claimed in claim 2, wherein said frame base has at least one slot disposed adjacent to said bill entrance in which said at least one pivot pin is installed, and a hole cut through one sidewall of each of said at least one slot in communication with said bill entrance for the passing of the stop bar of one said stop member.

5. The bill box as claimed in claim 2, wherein each said follower member has a push portion protruded from the base portion thereof; each said stop member has a push bar extended from the junction between the coupling base and stop bar of the respective stop member and suspending at one side relative to the push portion of one associating follower member.

6. The bill box as claimed in claim 1, wherein the pressure bar of each said follower member reduces gradually in diameter in direction away from the base portion of the respective follower member.

7. The bill box as claimed in claim 1, wherein each said follower member has a plurality of teeth protruded from a double beveled front side of the pressure bar thereof and arranged in a staggered manner.

8. The bill box as claimed in claim 1, wherein said non-return device comprises an axle member mounted in said frame base to pivotally support said at least one follower member; said bill-transfer wheel set comprises a bill-transfer roller pivotally mounted in said frame base, and a pinch roller pivotally mounted on said axle member in proximity to the periphery of said bill-transfer roller.

9. The bill box as claimed in claim 1, wherein said box body has a plurality of spring members mounted in a bottom side inside said accommodation chamber to support said a bearing board, and two stop flanges disposed at two opposite lateral sides of said opening for stopping said bearing board inside said accommodation chamber.

10. The bill box as claimed in claim 9, wherein said bill pusher device has a plurality of hooks protruded from one side thereof and projecting in direction toward said accommodation chamber, each hook of said bill pusher device having a sloping stop face disposed at one side remote from said bill entrance for stopping a bill from backward movement.

11. The bill box as claimed in claim 10, wherein the hooks of said bill pusher device are arranged in an array.

12. The bill box as claimed in claim 9, wherein said bill hold-down mechanism further comprises a plurality of wire barrier hooks arranged in said frame base and respectively extended from said stop blocks, each said wire barrier hook having a groove curving toward said accommodation chamber and two sloping guide faces at two sides of the groove.
